(19) United States
(12) Patent Application Publication
(10) Pub. No.: US 2026/0087565 A1
(43) Pub. Date: Mar. 26, 2026

(54) POWER GRID DEVICE PLUG-AND-PLAY TECHNIQUES AND ARCHITECTURES FOR AUTO-DISCOVERY

(71) Applicant: GE Infrastructure Technology LLC, Greenville, SC (US)

(72) Inventors: Balakrishna PAMULAPARTHY, Hyderabad (IN); David MACDONALD, Barcelona (ES); Mitalkumar KANABAR, Markham (CA); Lee HAYWARD, Cookstown (IE)

(73) Assignee: GE Infrastructure Technology LLC, Greenville, SC (US)

(21) Appl. No.: 18/893,749

(22) Filed: Sep. 23, 2024

(51) Int. Cl. G06Q 50/06; G06Q 10/0631; H02J 13/00

(52) U.S. Cl. CPC G06Q 50/06; G06Q 10/0631; H02J 13/12; H02J 13/13

(57) ABSTRACT

Methods, systems, and devices for automatically discovering and configuring intelligent electronic devices (IEDs) associated with power grids may determine, by a device adapter device, an address of an IED associated with a power substation; authenticating the IED to the device adapter device based on the address; receive, by a device adapter device, based on the authentication, device identifying information from an IED; provide, by the device adapter device, the device identifying information to an IED management system; identify, by the IED management system, based on the device identifying information, a firmware version currently used by the IED; identify, by the IED management system, based on the firmware version, additional device data of the IED; and update, by the IED management system, based on the additional data, a file of the IED.

### TECHNICAL FIELD

This disclosure generally relates to auto-discovery of devices, and more particularly to auto-discovery of intelligent electronic devices for power substations.

### BACKGROUND

Power substations are increasingly being automated using hardware and software controls. Automated substations may use many devices both inside and outside of power substations. Currently, there is no way to automatically detect the presence of a substation device and integrate the substation device with substation management systems.

### SUMMARY

A method of automatically discovering and configuring intelligent electronic devices (IEDs) associated with power grids, the method comprising: determining, by a device adapter device, an address of an IED associated with a power grid based on prior knowledge, network traffic scouting, or an encrypted discovery message published by the IED in a power network and including information about IED type and year of manufacture; authenticating the IED to the device adapter device based on the address and by sending an encrypted client authentication request message with a pre-defined username and a password that are based on the IED type and year of manufacture; receiving automatically, by a device adapter device, based on successful authentication of the IED to the device adapter, device identifying information from the IED, wherein the device identifying information comprises a set of information comprising a firmware version, an order code, an IED location, and an IED application; providing, by the device adapter device, the device identifying information to an IED management system, where in the device adapter is hosted on a communication router, a gateway, a cloud, or a virtual server to autonomously and securely connect IEDs with an IED management system; identifying, by the IED management system, based on the device identifying information, a data model version currently available and configured in the IED; automatically porting, by the IED management system, based on the IED application, an algorithm in the device adapter device to monitor or manage a condition of one or more primary assets associated with the IED application; identifying and instructing, by the IED management system, based on the data model version, additional device data and files to be retrieved from the IED by the device adapter device; determining, by the device adapter device, the condition of the one or more primary assets based on the ported algorithm, the data, and the files retrieved from the IED to inform any maintenance alert to an operator or directly perform a control action comprising at least one of updating a configuration setting, controlling an asset parameter, or tripping a breaker; and updating, by the IED management system, based on the additional device data, the files retrieved from the IED, and the condition of the one or more primary assets, wherein the updating is communicated by the device adapter device to a database server.

A system for automatically discovering and configuring intelligent electronic devices (IEDs) associated with power grids, the system comprising: an IED management system comprising memory coupled to at least one processor; and a device adapter device configured to: determine an address of an IED associated with a power grid based on prior knowledge, network traffic scouting, or an encrypted discovery message published by the IED in a power network and including information about IED type and year of manufacture; authenticate the IED to the device adapter device based on the address and by sending an encrypted client authentication request message with a pre-defined username and a password that are based on the IED type and year of manufacture; receive automatically, based on successful authentication of the IED to the device adapter, device identifying information from the IED, wherein the device identifying information comprises a set of information comprising a firmware version, an order code, an IED location, and an IED application; and provide the device identifying information to an IED management system, where in the device adapter is hosted on a communication router, a gateway, a cloud, or a virtual server to autonomously and securely connect IEDs with an IED management system, wherein the IED management system is configured to: identify, based on the device identifying information, a data model version currently available and configured in the IED; port, automatically, based on the IED application, an algorithm in the device adapter device to monitor or manage a condition of one or more primary assets associated with the IED application; identify and instruct, based on the data model version, additional device data and files to be retrieved from the IED by the device adapter device; determine the condition of the one or more primary assets based on the ported algorithm, the data, and the files retrieved from the IED to inform any maintenance alert to an operator or directly perform a control action comprising at least one of updating a configuration setting, controlling an asset parameter, or tripping a breaker; and update, based on the additional device data, the files retrieved from the IED, and the condition of the one or more primary assets, wherein the updating is communicated by the device adapter device to a database server.

A device for automatically discovering and configuring intelligent electronic devices (IEDs) associated with power grids, the device comprising memory coupled to at least one processor configured to: an address of an IED associated with a power grid based on prior knowledge, network traffic scouting, or an encrypted discovery message published by the IED in a power network and including information about IED type and year of manufacture; authenticate the IED to the device based on the address and by sending an encrypted client authentication request message with a pre-defined username and a password that are based on the IED type and year of manufacture; receive, automatically, based on successful authentication of the IED to the device, device identifying information from the IED, wherein the device identifying information comprises a set of information comprising a firmware version, an order code, an IED location, and an IED application; provide the device identifying information to an IED management system, where in the device is hosted on a communication router, a gateway, a cloud, or a virtual server to autonomously and securely connect IEDs with an IED management system; determine a condition of one or more primary assets associated with the IED application based on the ported algorithm, data and files retrieved from the IED to inform any maintenance alert to an operator or directly perform a control action comprising at least one of updating a configuration setting, controlling an asset parameter, or tripping a breaker; and communicate, to a database server, an update provided by the IED management system, wherein the update includes files retrieved from the IED, and the condition of the one or more primary assets.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows example systems for identifying and connecting intelligent electronic devices (IEDs) to a management system in accordance with one embodiment of the present disclosure.

FIG. 2 illustrates an example process of using the device adapter of FIG. 1 for plug and play of the 110 of FIG. 1 in accordance with one embodiment of the present disclosure.

FIG. 3 illustrates an example process of plug and play of the IED of FIG. 1 in accordance with one embodiment of the present disclosure.

FIG. 4 illustrates an example plug and play process of an IED using the device adapter of FIG. 1 in accordance with one embodiment of the present disclosure.

FIG. 5 illustrates an example system architecture for plug and play of IEDs using the device adapter of FIG. 1 in accordance with one embodiment of the present disclosure.

FIG. 6A is an example plug and play process of the IED of FIG. 1 in accordance with one embodiment of the present disclosure.

FIG. 6B is an example plug and play process of the IED of FIG. 1 in accordance with one embodiment of the present disclosure.

FIG. 6C is an example plug and play process of the IED of FIG. 1 in accordance with one embodiment of the present disclosure.

FIG. 7 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Power grids are increasingly being automated with software-defined automation solutions to enable utilities to ensure a stable, efficient energy supply. Part of the grid automation includes digitalizing power substations, autonomously managing grid zones, and remotely managing devices and communication networks. Device management (e.g., remote device management) may increase visibility across an entire fleet, down to individual secondary asset level, with techniques such as automatic device detection, remote device provisioning, and health monitoring. The present disclosure addresses automatic device detection of power substation devices.

Power substations are increasingly using intelligent electronic devices (IEDs) for collecting and recording parameters of power substations. The substation IEDs may include protection relays, smart meters, and the like. For example, IEDs may be microprocessor-based devices with processing and communication capabilities. A protection relay IED, for example, may receive data from current transformers and potential transformers, analyze the data, and issue commands to control devices such as breakers and switches.

With IEDs being added within and outside of substations, it is important to be able to identify the IEDs and configure them with a substation management system. However, there is currently no automatic detection of IEDs to facilitate remote provisioning and configuration of the IEDs, especially distribution IEDs (IEDs outside of the substation).

To communicate with and manage distribution IEDs, currently a gateway and a radio (e.g., router) are needed to connect the distribution IEDs to device management software (e.g., capable of remotely managing IEDs). The multiple hardware boxes for such connection are inconvenient, and manual device retrieval is time-consuming. Device updates sometimes require human operators to make local visits.

The enhanced device detection techniques herein may apply to grid device management, and other applications such as vehicle fleet management, portable device management, and the like, where there are devices being managed in different locations.

In one or more embodiments, a device adapter may integrate gateway functionality into a router to reduce the number of devices needed to connect substation IEDs to device management software. The device adapter may automatically discover IEDs and connect the IEDs to the device management software according to the techniques described herein.

In one or more embodiments, the device management software may read data and files from multiple IEDs in various locations. Because the IEDs may use different protocols, the device management software may support multiple device protocols for communication with the IEDs. The device management software may include a device adapter to recognize and apply the correct communication protocol of a respective IED so that the device management software may consume files and data from an IED using the protocol. The device adapter may be designed specifically for a respective type of IED (e.g., an IED using a particular communication protocol), or may be generic to communicate with multiple IEDs using different communication protocols. For example, the device adapter may use International Electrotechnical Commission (IEC) 61850 protocol as a generic adapter, or may be a specific adapter such as Modbus, an IEC 60870-104 protocol or a DNP (Distributed Network Protocol), or the like. The device adapter may function as an intermediate between an IED and the device management software, and may have modeling of the IED, which the device adapter may use to replace IED information, as required by the device management software, to write to an IED as required by the device management software, and the like.

With the number of IEDs increasing in the field, it is becoming more important to be able to remotely control them with device management software. For example, it is important to ensure that the IEDs have the correct firmware and configurations for their operations, and it is important that the device management software has updated and correct files and data from the IEDs to ensure proper operations of substations of a power grid. Currently, connecting to the IEDs requires significant manual entry of data. The enhanced auto-detection techniques herein ensure faster detection and communication with IEDs, and improve substation management by ensuring that the most updated and accurate data are provided.

In one or more embodiments, the device adapter may automatically identify an IED, determine the IED's functionality (e.g., based on the IED's firmware version), automatically connect to IEDs, and automatically download files and information from the IEDs (e.g., a plug-and-play device adapter).

In one or more embodiments, once a plug-and-play connection is established, the device management software may establish a plug-and-play database for the IED, and may create a profile for the IED for one or more IED applications.

In one or more embodiments, the device adapter may be part of a router, a gateway, an independent control system, a server, a cloud-based system, a virtualized platform, or the like.

In one or more embodiments, an IED may be pre-configured (e.g., by the device management software, prior to deployment) with “know the device” registers and a password mechanism (e.g., IED type and year of IED manufacture). The “know the device” information may be referred to herein as device identifying information (e.g., registers and password mechanism). When the IED is installed in the field, the Internet Protocol (IP) address of the IED may or may not be maintained (e.g., in an Enterprise Resource Planning ERP or Systems, Applications, and Products SAP server). If the IP address of an IED is available in ERP/SAP (and so may be the IED year/type), the IP address can be used by the device adapter to identify the preliminary password with which to connect the IED to the device adapter to read the “Know the Device” information. Alternatively, if the IP address of an IED is scouted from network packets by a router with specific packet header formats published by IEDs, then the IED type/year information part of the packet can be used by the device adapter to identify the preliminary password with which to connect the IED to the device adapter to read the “Know the Device” information. If the IP address of the IED is scouted from the network packets by router, but the IED cannot publish a specific packet header, then device adapter may send a connect request with pre-defined packet frame (along with a client certificate) for the IED to identify/authenticate it as a genuine client and then provide the IED's “Know the Device” information. The device adapter may identify a packet via network sniffing, for example.

The above descriptions are for purposes of illustration and are not meant to be limiting. Numerous other examples, configurations, processes, etc., may exist, some of which are described in greater detail below. Example embodiments will now be described with reference to the accompanying figures.

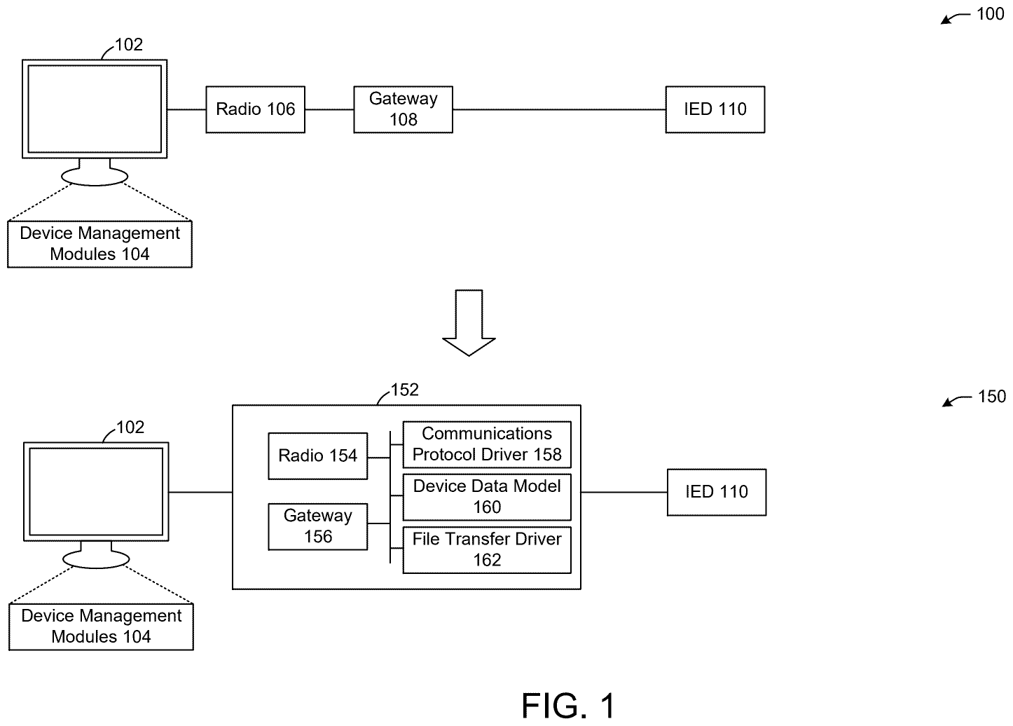

FIG. 1 shows example systems for identifying and connecting intelligent electronic devices (IEDs) to a management system in accordance with one embodiment of the present disclosure.

Referring to FIG. 1, a system 100 uses a device 102 with device management software (e.g., device management modules 104) to connect to and manage IEDs. The device management modules 104 may use a radio 106 to connect to a gateway 108, which may connect with remote IEDs (e.g., IED 110). The multiple hardware boxes (e.g., the radio 106 and the gateway 108) for such connection are inconvenient, and manual device retrieval is time-consuming. Device updates sometimes require human operators to make local visits.

Still referring to FIG. 1, another system 150 uses a device adapter 152 to identify and connect IEDs to the device management modules 104 of the device 102. The device adapter 152 may include a radio 154 and a gateway 156, each of which may connect to a communications protocol driver 158 of the device adapter 152, a device data model 160 of the device adapter 152, and a file transfer driver 162 of the device adapter 152. The device adapter 152 may automatically identify IEDs (e.g., the IED 110) and establish communication between the IEDs and the device management modules 104.

In one or more embodiments, the device adapter 152 may integrate gateway functionality (e.g., the gateway 156) to reduce the number of devices needed to connect substation IEDs to the device management modules 104. The device adapter 152 may automatically discover IEDs and connect the IEDs to the device management modules 104 according to the techniques described herein.

In one or more embodiments, the device management modules 104 may read data and files from the IED 110. Because IEDs may use different protocols, the device management modules 104 may support multiple device protocols (e.g., using the communications protocol driver 158) for communication with the IEDs. The device management modules 104 may use the device adapter 152 to recognize and apply the correct communication protocol of the IED 110 so that the device management modules 104 may consume files and data from the IED 110 using the protocol. The device adapter 152 may be designed specifically for a respective type of IED (e.g., an IED using a particular communication protocol), or may be generic to communicate with multiple IEDs using different communication protocols. For example, the device adapter 152 may use International Electrotechnical Commission (IEC) 61850 protocol as a generic adapter, or may be a specific adapter such as Modbus, DNP (Distributed Network Protocol), or the like. The device adapter 152 may function as an intermediate between the IED 110 and the device management modules 104, and may have modeling of the IED 110 (e.g., the device data model 160), which the device adapter 152 may use to replace IED information, as required by the device management modules 104, to write to the IED 110 as required by the device management modules 104, and the like.

In one or more embodiments, the device adapter 152 may automatically identify the IED 110, determine the IED's functionality (e.g., based on the IED's firmware version), automatically connect to IEDs, and automatically download files and information from the IEDs (e.g., a plug-and-play device adapter).

In one or more embodiments, once a plug-and-play connection is established, the device management modules 104 may establish a plug-and-play database for the IED 110, and may create a profile for the IED 110 for one or more IED applications.

In one or more embodiments, the device adapter 152 may be part of a router, a gateway, an independent control system, a server, a cloud-based system, a virtualized platform, or the like.

In one or more embodiments, the IED 110 may be pre-configured (e.g., by the device management modules 104, prior to deployment) with “know the device” registers and a password mechanism (e.g., IED type and year of IED manufacture). When the IED 110 is installed in the field, the Internet Protocol (IP) address of the IED 110 may or may not be maintained (e.g., in an Enterprise Resource Planning ERP or Systems, Applications, and Products SAP server). If the IP address of an IED 110 is available in ERP/SAP (and so may be the IED year/type), the IP address can be used by the device adapter 152 to identify the preliminary password with which to connect the IED 110 to the device adapter 152 to read the “Know the Device” information. Alternatively, if the IP address of the IED 110 is scouted from network packets by a router with specific packet header formats published by IEDs, then the IED type/year information part of the packet can be used by the device adapter 152 to identify the preliminary password with which to connect the IED 110 to the device adapter 152 to read the “Know the Device” information. If the IP address of the IED 110 is scouted from the network packets by router, but the IED 110 cannot publish a specific packet header, then device adapter 152 may send a connect request with pre-defined packet frame (along with a client certificate) for the IED 110 to identify/authenticate it as a genuine client and then provide the IED's “Know the Device” information.

The enhanced device detection techniques herein may apply to grid device management, and other applications such as vehicle fleet management, portable device management, and the like, where there are devices being managed in different locations. While FIG. 1 shows the enhanced techniques applying to the IED 110, the IED 110 may be replaced with vehicle fleet devices or other types of devices that may be automatically detected, connected, and configured using the device adapter 152.

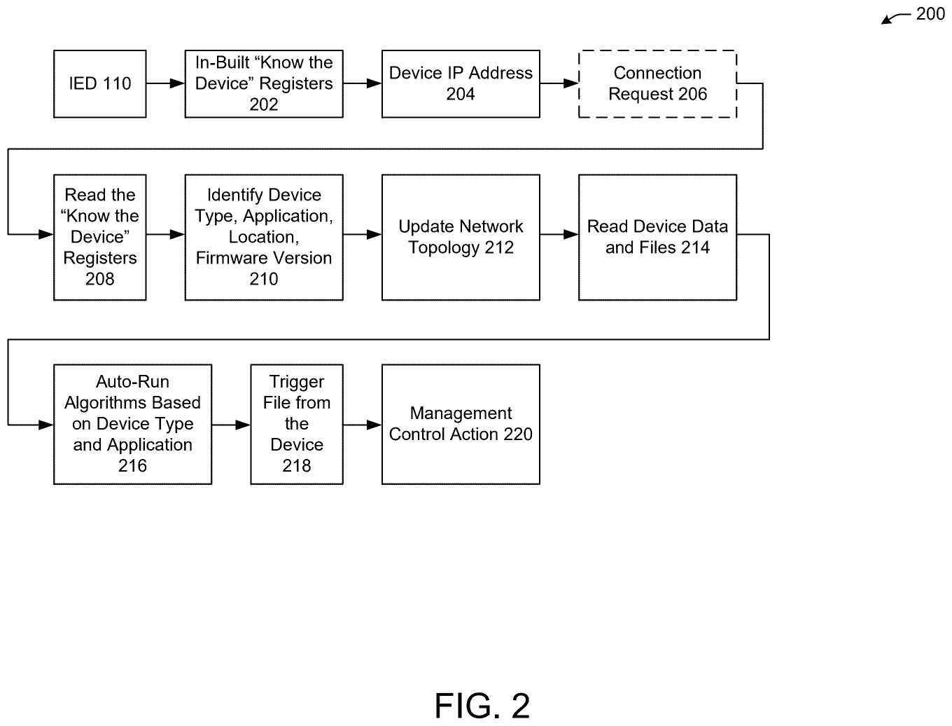

FIG. 2 illustrates an example process 200 of using the device adapter 152 of FIG. 1 for plug and play of the IED 110 of FIG. 1 in accordance with one embodiment of the present disclosure.

Referring to FIG. 2, the IED 110 may include in-built “know the device” registers 202 with a password mechanism (e.g., a device type and year of manufacture). If the IP (Internet Protocol) address of the IED 110 is available (e.g., in a SAP/ERP storage) at step 204, the device adapter 152 may use the IP address to identify a preliminary password with which to connect to the IED 110 to read the “know the device” registers of the IED 110. If the IP address of the IED 110 is scouted from network packets by a router with specific packet header formats published by the IED 110, then the IED type/year information part of the packet can be used by the device adapter 152 to identify the preliminary password to connect to the IED 110 to read the “know the device” registers of the IED 110. If the IP address of the IED 110 is scouted from network packets by the router, but the IED 110 cannot publish a specific packet header, then device adapter 152 may send a connection request 206 with pre-defined packet frame (e.g., plus a client certificate) for the IED 110 to identify/authenticate it as a genuine client and then provide the “know the device” register information. The connection request 206 may use Modbus or another communication protocol, and may use a pre-defined encrypted header frame. At step 208, the device adapter 152 may read the “know the device” registers of the IED 110 after authenticating the IED 110.

Still referring to FIG. 2, at step 210, the device adapter 152 may identify a configuration, application, location, and firmware version of the IED 110. At step 212, the device adapter 152 may update the network topology of a network with the location of the IED 110. At step 214, a secure login procedure may be used by the device adapter 152 to read data and files of the IED 110 based on the firmware version. At step 216, the device adapter 152 may automatically update and run algorithms based on the device type and application for the IED 110 (e.g., high-impedance algorithm, high-speed falling conductor protection algorithm, grid inertia algorithm, breaker algorithm, and the like). At block 218, the device adapter 152 may trigger a file (e.g.,. sv file and/or COMTRADE—Common Format for Transient Data Exchange for power systems—file) from the IED 110. At block 220, the device adapter 152 may facilitate a management control action (e.g., using the device management modules 104 of FIG. 1), such as an asset management action, a protection and control action, a distributed energy resource management action, or the like.

In one or more embodiments, at least steps 202-210 and 216 of FIG. 2 may be enhancements to existing techniques. By using the built-in “know the device” registers of the IED 110 (or any other device being automatically detected and configured by the device adapter 152), the IED 110 may be authenticated automatically, and device algorithms for the IED 110 may be run automatically as a result at step 216.

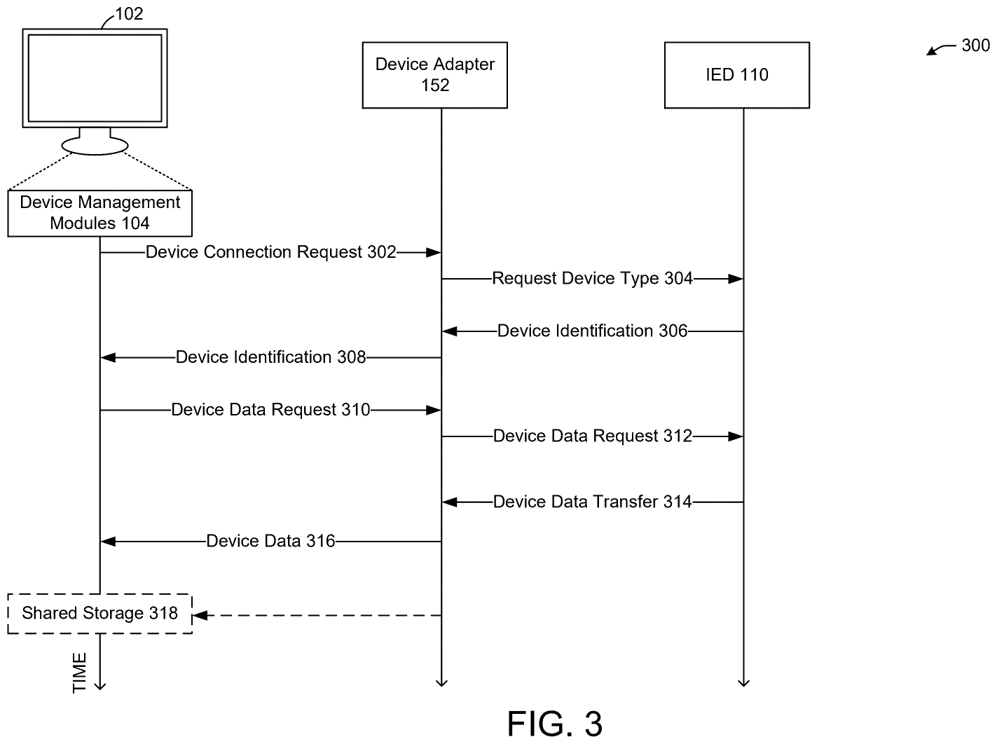

FIG. 3 illustrates an example process 300 of plug and play of the IED 110 of FIG. 1 in accordance with one embodiment of the present disclosure.

Referring to FIG. 3, the process may include the device 102 with the device management modules 104 of FIG. 1, the device adapter 152, and the IED 110. The device 102 may send a connection request 302 to the device adapter 152 to request the device adapter 152 to show any IEDs. The device adapter 152 may send a device type request 304 to which an IED may respond. The IED 110 may receive the device type request 304 and may provide device identification 306 to the device adapter 152, which may provide device identification 308 of the IED 110 and any other identified IEDs to the device 102. The device 102 may send a device data request 310 to the device adapter 152 for information about any of the identified IEDs. The device adapter 152 may send a device data request 312 to the identified IEDs, which may respond with a device data transfer 314. The device adapter 152 may provide the device data 316, received in the device data transfer 314, to the device 102. Optionally, at step 318, the device adapter 152 may create a shared storage with the device management modules 104. The shared storage may include a COMTRADE event log and/or CID file or other type of settings file for the IED 110. In this manner, the process 300 may represent an auto-connection approach with a simplified architecture, deployment, and configuration with reduced hardware in between the device 102 and the IED 110.

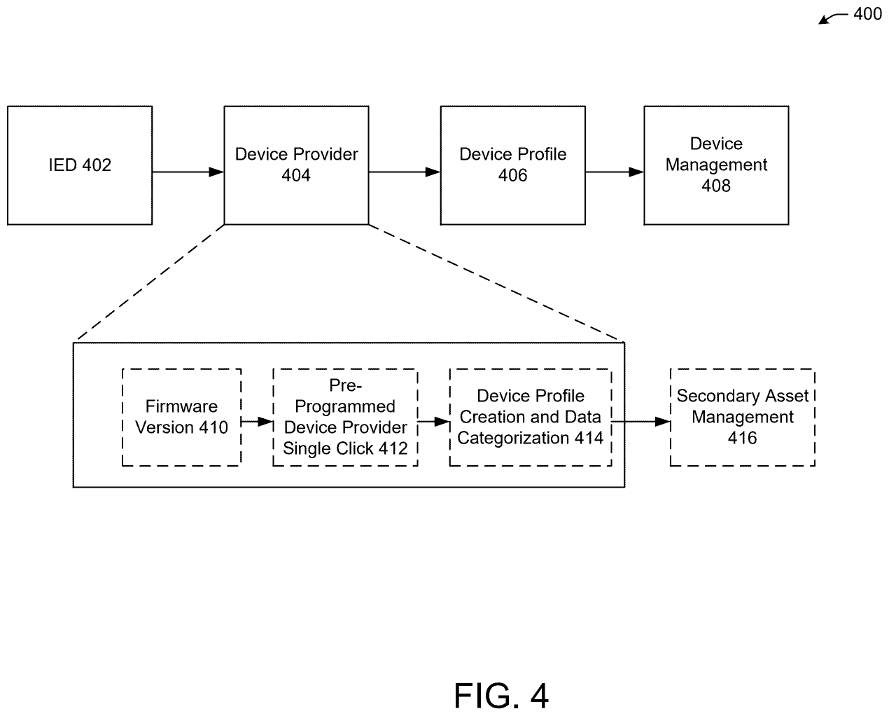

FIG. 4 illustrates an example plug and play process 400 of an IED using the device adapter 152 of FIG. 1 in accordance with one embodiment of the present disclosure.

Referring to FIG. 4, the process 400 may include an IED 402 (e.g., similar to the IED 110 of FIG. 1), which may have a device type, a device family, an application, and an IP address. The process 400 may include the device adapter 152, which may identify the firmware version of the IED 402 and may perform auto-connection with and auto-downloading of data from the IED 402. The process 400 may include a device profile 406, which may indicate whether the IED 402 is operational or non-operational, the communication protocol used by the IED 402, cyber security of the IED 402, and performance of the IED 402. The process 400 may include a device management 408 (e.g., the device management modules 104 of FIG. 1), which may be operational or non-operational, may management communication with one or more communication protocols, may manage cyber security, and may manage device performance. In one or more embodiments, the device profile 406 may include an example baseline profile, which may be based on a number of IED settings, latency, certificates, device performance, firmware versions, calibration, users, device manufacturing year, and/or other technical specifications of the IED 402.

Still referring to FIG. 4, the device adapter 152 optionally identify the firmware version 410 of the IED 402, run pre-programmed device provider algorithms using a single click approach as described above at step 412, and may perform at step 414 a device profile creation and data categorization within a database or other storage. As a result, a secondary asset management 416 of the IED 402 optionally may be facilitated by the device adapter 152.

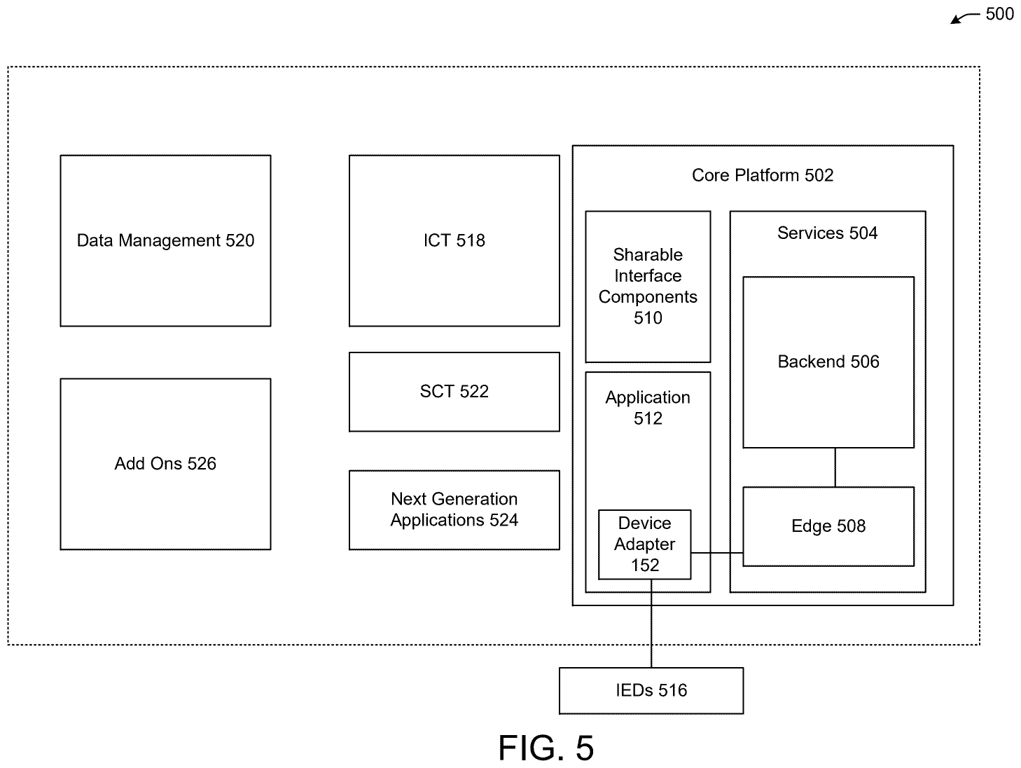

FIG. 5 illustrates an example system architecture 500 for plug and play of IEDs using the device adapter 152 of FIG. 1 in accordance with one embodiment of the present disclosure.

Referring to FIG. 5, the system architecture 500 may include a core platform 502 with services 504 (e.g., a resource translator, proxy authentication, resources, configuration, rule engine, storage, maintenance, monitoring, scheduling, calculation, and alert/alarm notification messenger). The services 504 may operate in a backend 506 that may connect to an edge 508, which may communicate with the device adapter 152. The core platform 502 may include sharable interface components 510 (e.g., user interface/user experience components) and an application 512 (e.g., for a COMTRADE or other application). The device adapter 152 may connect to IEDs 516 or other devices automatically, and may connect to the backend 506 via the edge 508 to automatically configure the IEDs 516.

Still referring to FIG. 5, the system architecture 500 may include an IED configuration tool (ICT 518), data management 520 (e.g., fleet management, monitoring software, adapters, firmware, etc.), a system configuration tool (SCT 522 for configuring SCD files based on the IEC 61850 standard), next generation applications 524 (e.g., user interface, parser, report generation, etc.), and add ons 526 (e.g., mediator, collaboration manager, password management, etc.).

In one or more embodiments, the device adapter 152 may use one or more communication protocols, such as Modbus, Sftp, or otherwise, with which to communicate with the IEDs 516 based on the communication protocols of the IEDs 516. In this manner, the device adapter 152 may detect IEDs of any communication protocol and may automatically authenticate and configure them using the device management modules 104 of FIG. 1.

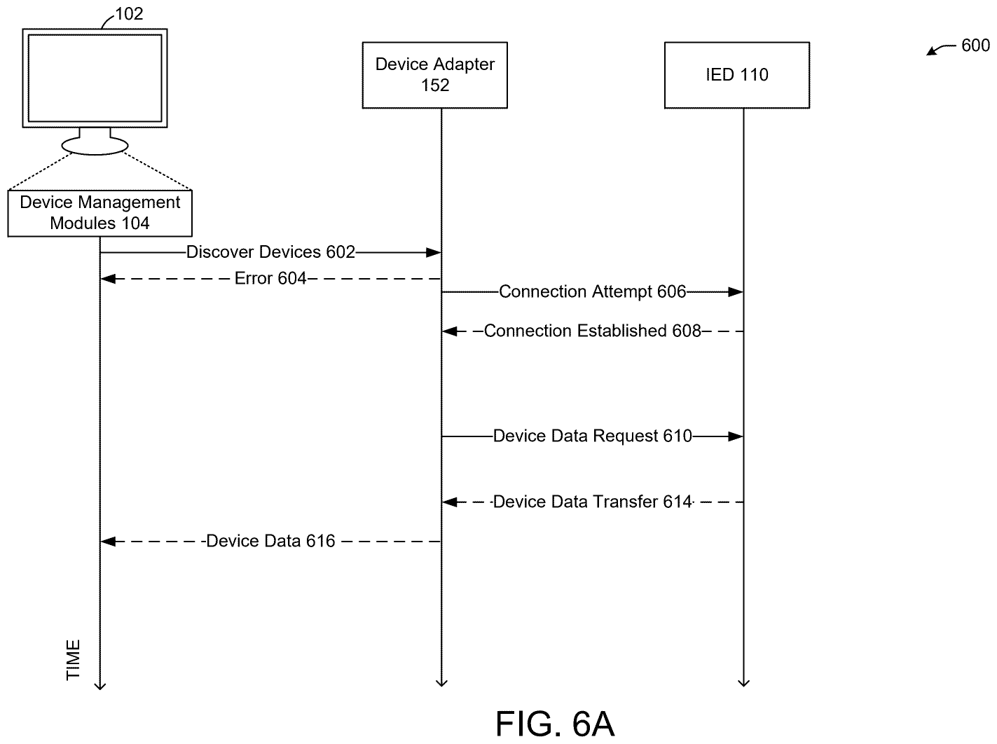

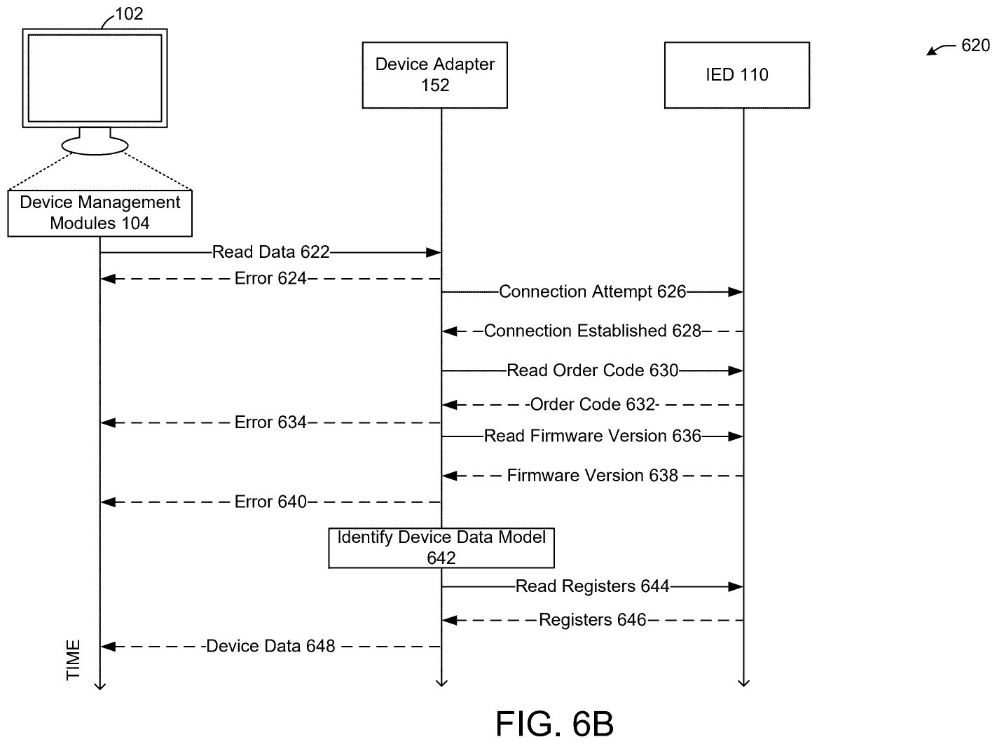

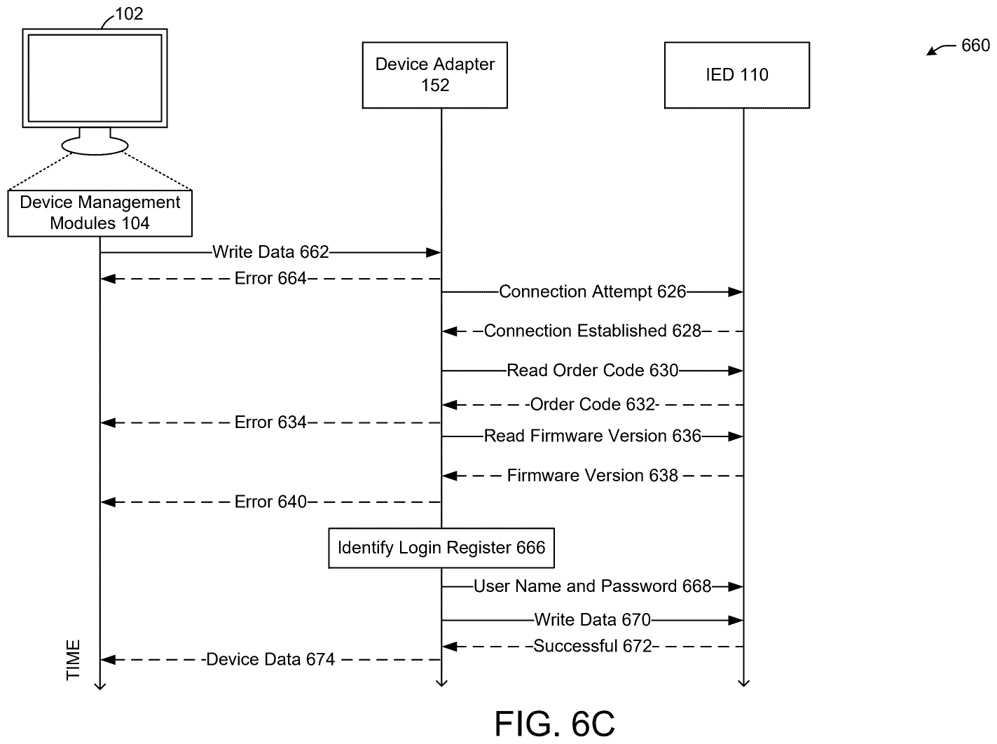

FIG. 6A is an example plug and play process 600 of the IED 110 of FIG. 1 in accordance with one embodiment of the present disclosure.

Referring to FIG. 6A, the device 102 with the device management modules 104 of FIG. 1 may send a discover devices request 602 to the device adapter 152 to discover any devices to be managed by the device management modules 104 (e.g., a gRPC remote procedure request). If validation fails (e.g., due to invalid IP address or count), an error 604 may be provided to the device 102 (e.g., with a gRPC status code and invalid argument indicator). The device adapter 152 may perform a connection attempt 606 for an IP address (e.g., at a Modbus port), and optionally a connection may be established at step 608. The device adapter 152 may send a device data request 610 to read metadata of the IED 110 (e.g., serial number, firmware version, etc.). Optionally, the IED 110 may provide a device data transfer 614 to the device adapter 152 (e.g., including the requested metadata). Optionally, at step 616, the device adapter 152 may stream the device data to the device 102 for the device management modules 104. The process 600 may repeat for additional IED IP addresses.

FIG. 6B is an example plug and play process 620 of the IED 110 of FIG. 1 in accordance with one embodiment of the present disclosure.

Referring to FIG. 6B, the device 102 with the device management modules 104 of FIG. 1 may send a read data request 622 to the device adapter 152 (e.g., a gRPC remote procedure request). Optionally, if a Modbus connection fails, an error 624 may be provided to the device 102. The device adapter 152 may connect to and log into the IED 110 via a connection attempt 626 and connection establishment 628 response. The device adapter 152 may send a read order code request 630 to the IED 110, and may receive the order code 632 from the IED 110. When an error occurs with the device adapter 152 attempting to receive the order code, the device adapter 152 may send an error message 634 to the device 102. When the order code is received by the device adapter 152, the device adapter 152 may send a read request 636 for the firmware version to the IED 110, which may respond with the firmware version 638 used by the IED 110. When the firmware version 638 is not provided to the device adapter 152, the device adapter 152 may notify the device 102 with an error message 640. Based on the firmware version 638, the device adapter 152 may identify a device data model 642 for the IED 110, and may send a read request 644 for registers of the IED 110, which may respond with its registers 646. The device adapter 152 may provide device data 648 to the device 102 based on receiving the registers 646 of the IED 110.

FIG. 6C is an example plug and play process 660 of the IED of FIG. 1 in accordance with one embodiment of the present disclosure.

Referring to FIG. 6C, the device 102 with the device management modules 104 of FIG. 1 may send a write data request 662 to the device adapter 152 (e.g., a gRPC remote procedure request). When the write data request 662 fails, the device adapter 152 may send an error message 664 to the device 102. When the write data request 662 succeeds, the device adapter 152 may connect to the IED 110 via a connection attempt 626 and connection establishment 628 response. The device adapter 152 may send a read order code request 630 to the IED 110, and may receive the order code 632 from the IED 110. When an error occurs with the device adapter 152 attempting to receive the order code, the device adapter 152 may send an error message 634 to the device 102. When the order code is received by the device adapter 152, the device adapter 152 may send a read request 636 for the firmware version to the IED 110, which may respond with the firmware version 638 used by the IED 110. When the firmware version 638 is not provided to the device adapter 152, the device adapter 152 may notify the device 102 with an error message 640. Based on the firmware version 638, the device adapter 152 may identify a login register 666 for the IED 110, including a user name and password 668 with which the device adapter 152 may log into the IED 110. Once the device adapter 152 has logged into the IED 110, the device adapter 152 may send a write data request 670 to write data to the IED 110, and when the write data request 670 is successful 672, the device adapter 152 may provide device data 674 of the IED 110 to the device 102.

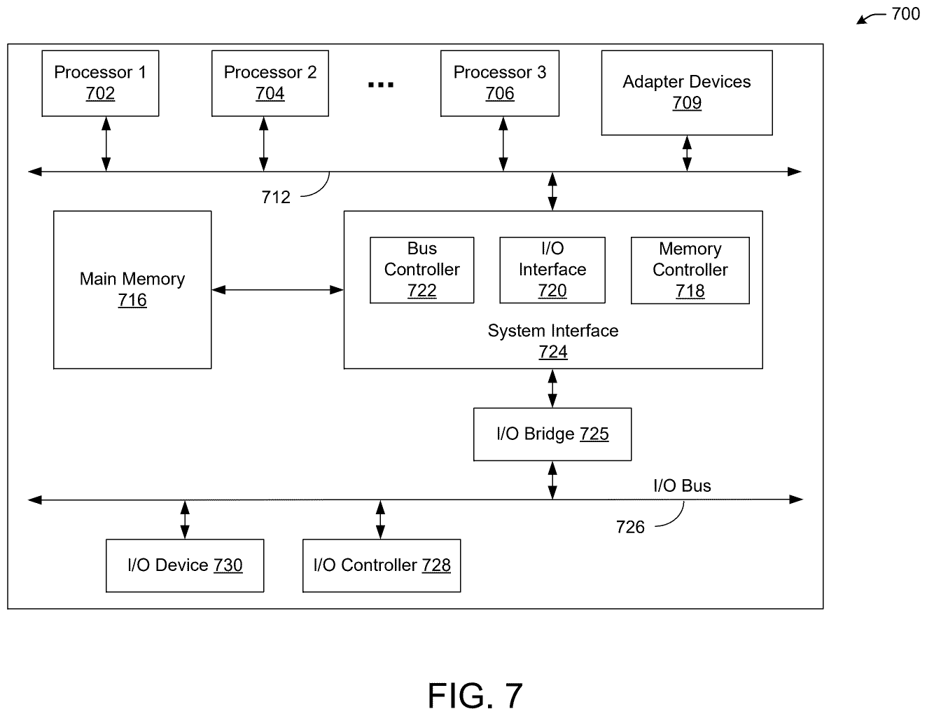

FIG. 7 is a diagram illustrating an example of a computing system 700 that may be used in implementing embodiments of the present disclosure.

For example, the computing system 700 of FIG. 7 may represent at least a portion of the components of FIG. 1, and discussed above. The computer system (system) includes one or more processors 702-706 and one or more adapter devices 709 (e.g., representing device adapter 152 of FIG. 1, capable of performing any operations described with respect to FIGS. 1-6C). Processors 702-706 may include one or more internal levels of cache (not shown) and a bus controller 722 or bus interface unit to direct interaction with the processor bus 712. Processor bus 712, also known as the host bus or the front side bus, may be used to couple the processors 702-706 with the system interface 724. System interface 724 may be connected to the processor bus 712 to interface other components of the system 700 with the processor bus 712. For example, system interface 724 may include a memory controller 718 for interfacing a main memory 716 with the processor bus 712. The main memory 716 typically includes one or more memory cards and a control circuit (not shown). System interface 724 may also include an input/output (I/O) interface 720 to interface one or more I/O bridges 725 or I/O devices with the processor bus 712. One or more I/O controllers and/or I/O devices may be connected with the I/O bus 726, such as I/O controller 728 and I/O device 730, as illustrated.

I/O device 730 may also include an input device (not shown), such as an alphanumeric input device, including alphanumeric and other keys for communicating information and/or command selections to the processors 702-706. Another type of user input device includes cursor control, such as a mouse, a trackball, or cursor direction keys for communicating direction information and command selections to the processors 702-706 and for controlling cursor movement on the display device.

System 700 may include a dynamic storage device, referred to as main memory 716, or a random access memory (RAM) or other computer-readable devices coupled to the processor bus 712 for storing information and instructions to be executed by the processors 702-706. Main memory 716 also may be used for storing temporary variables or other intermediate information during execution of instructions by the processors 702-706. System 700 may include a read only memory (ROM) and/or other static storage device coupled to the processor bus 712 for storing static information and instructions for the processors 702-706. The system outlined in FIG. 7 is but one possible example of a computer system that may employ or be configured in accordance with aspects of the present disclosure.

According to one embodiment, the above techniques may be performed by computer system 700 in response to processor 704 executing one or more sequences of one or more instructions contained in main memory 716. These instructions may be read into main memory 716 from another machine-readable medium, such as a storage device. Execution of the sequences of instructions contained in main memory 716 may cause processors 702-706 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 716, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

It is understood that the above descriptions are for purposes of illustration and are not meant to be limiting.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method of automatically discovering and configuring intelligent electronic devices (IEDs) associated with power grids, the method comprising:
determining, by a device adapter device, an address of an IED associated with a power grid based on prior knowledge, network traffic scouting, or an encrypted discovery message published by the IED in a power network and including information about IED type and year of manufacture;
authenticating the IED to the device adapter device based on the address and by sending an encrypted client authentication request message with a pre-defined username and a password that are based on the IED type and year of manufacture;
receiving automatically, by a device adapter device, based on successful authentication of the IED to the device adapter, device identifying information from the IED, wherein the device identifying information comprises a set of information comprising a firmware version, an order code, an IED location, and an IED application;
providing, by the device adapter device, the device identifying information to an IED management system, where in the device adapter is hosted on a communication router, a gateway, a cloud, or a virtual server to autonomously and securely connect IEDs with an IED management system;
identifying, by the IED management system, based on the device identifying information, a data model version currently available and configured in the IED;
automatically porting, by the IED management system, based on the IED application, an algorithm in the device adapter device to monitor or manage a condition of one or more primary assets associated with the IED application;
identifying and instructing, by the IED management system, based on the data model version, additional device data and files to be retrieved from the IED by the device adapter device;
determining, by the device adapter device, the condition of the one or more primary assets based on the ported algorithm, the data, and the files retrieved from the IED to inform any maintenance alert to an operator or directly perform a control action comprising at least one of updating a configuration setting, controlling an asset parameter, or tripping a breaker; and
updating, by the IED management system, based on the additional device data, the files retrieved from the IED, and the condition of the one or more primary assets, wherein the updating is communicated by the device adapter device to a database server.

2. The method of claim 1, further comprising:
sending, by the IED management system, a request for IED data; and
retrieving, by the device adapter device, based on the request, the address from a server.

3. The method of claim 1, further comprising:
identifying, via network sniffing performed by the device adapter device, a packet transmitted by the IED on the power network,
wherein determining the address is based on identifying the address in a header of the packet.

4. The method of claim 1, further comprising:
receiving, by the device adapter device, a discovery packet auto-published by the IED on the power network;
identifying, bye device adapter device, from the discovery packet, an IED type and year of manufacture with which to determine a predefined authentication mechanism;
sending, by the device adapter device, a connection request to the IED to authenticate the device adapter device; and
receiving, by the device adapter device, the device identifying information.

5. The method of claim 1, wherein the IED is located outside of any substations in the power grid.

6. The method of claim 1, wherein the device adapter device communicates with the IED using a Modbus protocol.

7. The method of claim 1, wherein the device adapter device communicates with the IED using an International Electrotechnical Commission (IEC) 60870-104 protocol or a DNP (Distributed Network Protocol).

8. The method of claim 1, wherein the device adapter device communicates with the IED using an International Electrotechnical Commission (IEC) 61850 protocol.

9. The method of claim 1, wherein the files comprise at least one of a Common Format for Transient Data Exchange for power systems (COMTRADE) file, a configuration settings file, a fault record, a data log, a system log, or an historical data file.

10. The method of claim 1, further comprising:
updating a network topology of power substations, comprising the power substation, based on the device identifying information.

11. A system for automatically discovering and configuring intelligent electronic devices (IEDs) associated with power grids, the system comprising:
an IED management system comprising memory coupled to at least one processor; and
a device adapter device configured to:
determine an address of an IED associated with a power grid based on prior knowledge, network traffic scouting, or an encrypted discovery message published by the IED in a power network and including information about IED type and year of manufacture;
authenticate the IED to the device adapter device based on the address and by sending an encrypted client authentication request message with a pre-defined username and a password that are based on the IED type and year of manufacture;
receive automatically, based on successful authentication of the IED to the device adapter, device identifying information from the IED, wherein the device identifying information comprises a set of information comprising a firmware version, an order code, an IED location, and an IED application; and
provide the device identifying information to an IED management system, where in the device adapter is hosted on a communication router, a gateway, a cloud, or a virtual server to autonomously and securely connect IEDs with an IED management system,
wherein the IED management system is configured to:
identify, based on the device identifying information, a data model version currently available and configured in the IED;
port, automatically, based on the IED application, an algorithm in the device adapter device to monitor or manage a condition of one or more primary assets associated with the IED application;
identify and instruct, based on the data model version, additional device data and files to be retrieved from the IED by the device adapter device;
determine the condition of the one or more primary assets based on the ported algorithm, the data, and the files retrieved from the IED to inform any maintenance alert to an operator or directly perform a control action comprising at least one of updating a configuration setting, controlling an asset parameter, or tripping a breaker; and
update, based on the additional device data, the files retrieved from the IED, and the condition of the one or more primary assets, wherein the updating is communicated by the device adapter device to a database server.

12. The system of claim 11, wherein the IED management system is further configured to:
send a request for IED data, and wherein the device adapter device is further configured to:
retrieve, based on the request, the address from a server.

13. The system of claim 11, wherein the device adapter device is further configured to:
identify, based on network sniffing performed by the device adapter device, a packet transmitted by the IED on the power network, and
wherein to determine the address is based on identifying the address in a header of the packet.

14. The system of claim 11, wherein the device adapter device is further configured to:
receive a discovery packet auto-published by the IED on the power network;
identify, from the discovery packet, an IED type and year of manufacture with which to determine a predefined authentication mechanism;
send a connection request to the IED to authenticate the device adapter device; and
receive the device identifying information from the IED upon successful authentication.

15. The system of claim 11, wherein the IED is located outside of any substations in the power grid.

16. A device for automatically discovering and configuring intelligent electronic devices (IEDs) associated with power grids, the device comprising memory coupled to at least one processor configured to:
an address of an IED associated with a power grid based on prior knowledge, network traffic scouting, or an encrypted discovery message published by the IED in a power network and including information about IED type and year of manufacture;
authenticate the IED to the device based on the address and by sending an encrypted client authentication request message with a pre-defined username and a password that are based on the IED type and year of manufacture;
receive, automatically, based on successful authentication of the IED to the device, device identifying information from the IED, wherein the device identifying information comprises a set of information comprising a firmware version, an order code, an IED location, and an IED application;
provide the device identifying information to an IED management system, wherein the device is hosted on a communication router, a gateway, a cloud, or a virtual server to autonomously and securely connect IEDs with an IED management system;
determine a condition of one or more primary assets associated with the IED application based on the ported algorithm, data and files retrieved from the IED to inform any maintenance alert to an operator or directly perform a control action comprising at least one of updating a configuration setting, controlling an asset parameter, or tripping a breaker; and
communicate, to a database server, an update provided by the IED management system, wherein the update includes files retrieved from the IED, and the condition of the one or more primary assets.

17. The device of claim 16, wherein the at least one processor is further configured to:
send a request for IED data, and
retrieve, based on the request, the address from a server.

18. The device of claim 16, wherein the at least one processor is further configured to:
identify, based on network sniffing performed by the device, a packet transmitted by the IED on the power network, and
wherein to determine the address is based on identifying the address in a header of the packet.

19. The device of claim 16, wherein the at least one processor is further configured to:
receive a discovery packet auto-published by the IED on the power network;
identify, from the discovery packet, the IED type and year of manufacture with which to determine a predefined authentication mechanism;
send a connection request to the IED to authenticate the device; and
receive the device identifying information from the IED upon successful authentication.

20. The device of claim 16, wherein the IED is located outside of any substations in the power grid.
